(19) United States
(12) Patent Application Publication
(10) Pub. No.: US 2026/0368552 A1
(43) Pub. Date: Nov. 19, 2026

(54) FULL-LIFECYCLE ARTIFICIAL-INTELLIGENCE GUIDANCE PLATFORM WITH LONG-TERM MEMORY, RELATIONSHIP GRAPH, STAGE-SPECIFIC CONTEXT ASSEMBLY, ACTION ORCHESTRATION, DETERMINISTIC AXIOM RETRIEVAL, AND AUDITABLE LIFECYCLE TRANSITION SUPPORT

(71) Applicant: CHUANPING HU, Pittsburg, KS (US)

(72) Inventor: CHUANPING HU, Pittsburg, KS (US)

(21) Appl. No.: 19/652,287

(22) Filed: Apr. 20, 2026

(51) Int. Cl. G06N 5/022

(52) U.S. Cl. CPC G06N 5/022

(57) ABSTRACT

A computer-implemented dual-presence lifecycle support system is disclosed. A registration event received through a lifecycle-support application instantiates a paired human-companion account including a structured human profile, a structured artificial-intelligence companion profile, and an initial permission and continuity configuration. The system selectively synchronizes records between a human profile store and a companion profile store, determines whether tasks are processed in a human-active mode, a companion-active mode, or a combined human-companion mode, and performs delegated operations during periods in which the human user is offline, inactive, unavailable, sleeping, traveling, or otherwise not actively interacting with the system. The coordinated operation defines a composite human-artificial-intelligence continuity entity comprising both human-associated and artificial-intelligence-associated operational components under one or more allocation parameters. The system further supports digital-twin status reporting, governance enforcement, continuity storage, legacy-preservation modes, and optional distributed verification.

### CROSS-REFERENCE TO RELATED APPLICATIONS

This application is related to, and may claim priority to or otherwise be coordinated with, one or more applications directed to foundational artificial-intelligence safety systems, world economic operating systems, world financing operating systems, social-artificial-intelligence integration systems, and/or lifecycle-oriented guidance architectures, the disclosures of which are incorporated herein by reference to the extent not inconsistent herewith.

In particular embodiments, the present application may be prosecuted as a standalone utility application, a continuation, a continuation-in-part where new matter is expressly included, a divisional, or a family member coordinated with broader patent filings directed to Human Civilization 5.0, Human Species 2.0, a hybrid social-AI application, H App, H AI, AI safety architectures, or platform-level social-artificial-intelligence systems.

### FIELD OF THE INVENTION

The present disclosure relates generally to computer-implemented artificial-intelligence systems and human-computer interaction systems. More specifically, the present disclosure relates to a full-lifecycle artificial-intelligence guidance platform that maintains long-term memory, structured profile records, relationship graphs, stage-specific context packages, action plans, collaborative workflows, and auditable lifecycle-transition support for users across multiple life stages.

More specifically, the disclosure relates to a computer-implemented system that integrates a structured lifecycle-navigation architecture with a deterministic axiom database, a constrained retrieval and compilation pipeline, and one or more action-trigger interfaces, so as to reduce hallucination, misalignment, and non-actionable output in conventional generative systems when processing life-stage-specific human inquiries.

In some embodiments, the disclosure further relates to a hybrid social-AI application environment in which a real-time social layer and an embedded guidance layer coexist within a unified interface, thereby reducing fragmentation between social interaction and life-guidance interaction.

### BACKGROUND OF THE INVENTION

Digital assistants, chatbots, search engines, recommendation engines, and conventional social platforms typically process user interactions in a fragmented and session-limited manner. Even where conventional systems provide personalized responses, they often fail to maintain structured long-term context over years of user development, relationships, responsibilities, and changing priorities.

Conventional systems also tend to optimize for isolated query answering, generic content generation, engagement maximization, or narrow workflow automation. Such systems often do not reliably track a user's changing stage of life, do not maintain a structured relationship graph reflecting family, mentoring, caregiving, educational, partnership, or social ties, and do not convert guidance into machine-managed action plans that can be revisited, re-evaluated, and audited over time.

For example, a child user may require learning-oriented support, a teenager may require educational and identity-development support, a young adult may require academic, social, and career-transition support, an adult may require family, work, parenting, or caregiving support, an elder may require aging and care coordination support, and a legacy-stage user may require memory preservation, value transmission, or end-of-life planning support. Conventional systems do not adequately maintain continuity across these transitions.

Similarly, conventional systems often do not preserve both private and shared memory structures. A user may wish to maintain private reflective records while also authorizing selective shared records for parents, partners, children, caregivers, mentors, or other associated persons. Existing chat systems and social systems usually do not provide a robust lifecycle-aware architecture for such coordinated memory, guidance, and collaborative action.

Moreover, many conventional systems do not store auditable records associating user inputs, state classifications, selected context elements, routing logic, output generation, follow-up actions, and outcomes. As a result, users, families, operators, and regulators may lack the ability to understand how guidance was produced, how action plans evolved, and how lifecycle transitions were handled.

Conventional probabilistic large-language-model systems generate responses based on token-probability completion and therefore may fail to provide deterministic, traceable, and execution-linked guidance for users confronting educational, vocational, relational, health, aging, or intergenerational questions.

Conventional social platforms also fail to provide a seamless transition from social interaction to traceable, axiom-locked guidance within the same interface, thereby forcing users to fragment emotionally significant decisions across multiple disconnected systems.

In addition, existing systems generally lack a fail-safe mechanism that can revert to a purely deterministic, non-probabilistic guidance mode when external inference conflicts with authorized axiomatic or safety constraints.

Accordingly, there remains a need for an improved artificial-intelligence platform that can: (i) classify and update lifecycle states; (ii) maintain long-term structured memory; (iii) maintain a relationship graph associated with the user; (iv) assemble stage-specific context packages; (v) generate personalized and relationship-aware outputs; (vi) convert such outputs into action plans and collaborative workflows; (vii) schedule and trigger re-evaluation; and (viii) preserve auditable records across long time horizons.

### SUMMARY OF THE INVENTION

The present disclosure provides a computer-implemented lifecycle guidance platform system that supports users across multiple life stages using long-term memory, structured profile records, relationship graphs, stage-specific context assembly, model routing, personalized guidance generation, action orchestration, scheduling, and auditable lifecycle-transition support.

In one aspect, the disclosure provides a platform comprising one or more processors, a user interface, a profile store, a lifecycle-state engine, a long-term memory store, a relationship-graph engine, a context assembly engine, a model-routing engine, a guidance engine, an action-plan engine, a scheduler, and an audit layer.

In another aspect, the lifecycle-state engine classifies a user into a current lifecycle state selected from multiple lifecycle states, such as childhood, adolescence, young adulthood, adulthood, elderhood, and legacy-planning, and optionally predicts a transitional state or assigns a lifecycle sub-state.

In another aspect, the long-term memory store stores event-linked memory records and persistent user records, optionally organized into private memory partitions and shared memory partitions.

In another aspect, the relationship-graph engine maintains a machine-readable graph representing relationships between the user and one or more associated persons, such as family members, teachers, mentors, partners, children, caregivers, peers, or collaborators. Weighted values may be assigned to such relationships.

In another aspect, the context assembly engine generates a stage-specific context package using lifecycle state, profile data, memory data, graph data, priorities, and unresolved tasks. A model-routing engine may route the context package to one or more artificial-intelligence inference engines according to routing rules.

In another aspect, the guidance engine generates one or more personalized guidance outputs, including outputs tailored for the user and optionally outputs tailored for associated persons. The action-plan engine converts generated guidance into immediate actions, deferred actions, collaborative tasks, reminders, or checkpoints.

In another aspect, the scheduler assigns re-evaluation times or trigger conditions. Re-evaluation may occur based on time expiration, user completion, non-completion, new event detection, or lifecycle transition.

In another aspect, an audit layer stores auditable records, explanation objects, and outcome states associated with lifecycle guidance operations.

In another aspect, the disclosure provides methods and non-transitory computer-readable media implementing the foregoing functionality.

In some embodiments, the platform further includes a cryptographically protected deterministic axiom database in which authorized guidance records are hash-locked and retrieved without probabilistic modification.

In some embodiments, the user interface further presents a persistent or floating guidance invocation control enabling a user to transition from social-feed interaction to guided-query interaction within a unified session context.

In some embodiments, the platform further maintains a legacy-preservation vault configured to store selected messages, values, continuity instructions, or family-support content for future controlled access.

In some embodiments, the guidance output includes or is associated with an executable action-link object configured to trigger registration, scheduling, financing-interface access, educational-path activation, health-plan enrollment, or other machine-enabled follow-up operations.

In some embodiments, the platform further includes a fail-safe pure-axiom mode switch and an axiomatic logic gate configured to disconnect or restrict one or more external model pathways when a verification layer detects inconsistency with authorized axiomatic constraints.

In some embodiments, the platform is configured to receive and process lifecycle-specific uncertainty queries comprising educational-transition inputs, AGI-era anxiety inputs, survival-assurance inputs, intergenerational concern inputs, or other human-development, caregiving, aging, or legacy-oriented inputs.

In some embodiments, one or more priority ranking objects apply an ethical weighting or weak-group prioritization rule when ranking possible actions, resources, or guidance paths, thereby favoring a deterministically identified high-impact path for a vulnerable, caregiving-dependent, under-supported, or intergenerationally affected user.

In some embodiments, the long-term memory store and associated permission controls maintain layered access between a safety-kernel record subset and a prosperity-engine record subset, thereby allowing more restrictive governance for safety-critical records while permitting authorized use of non-safety planning, flourishing, or prosperity-oriented records.

The disclosed platform thereby improves continuity, personalization, lifecycle-awareness, relationship-awareness, actionability, and auditability over conventional artificial-intelligence systems and conventional social systems.

### BRIEF DESCRIPTION OF THE DRAWINGS

FIG. 1 is a schematic block diagram of a lifecycle guidance platform system including a user interface, profile store, lifecycle-state engine, long-term memory store, relationship-graph engine, context assembly engine, model-routing engine, guidance engine, action-plan engine, scheduler, and audit layer.

FIG. 2 is a lifecycle-state transition diagram illustrating transitions among childhood, adolescent, young-adult, adult, elder, and legacy-planning states, including sub-state transitions and trigger conditions.

FIG. 3 is a schematic diagram of example data structures including structured profile records, memory records, relationship graph records, action records, and audit records.

FIG. 4 is a process flow diagram illustrating stage-specific context assembly, model routing, personalized guidance generation, and output generation.

FIG. 5 is a process flow diagram illustrating action-plan generation, collaborative task generation, scheduler operations, and re-evaluation triggering.

FIG. 6 is a schematic diagram illustrating audit-layer storage, explanation-object generation, and outcome tracking associated with lifecycle guidance operations.

FIG. 7 is an example user interface view showing a longitudinal lifecycle view, prior lifecycle states, current lifecycle state, pending actions, completed actions, and associated persons.

FIG. 8 is a process flow diagram illustrating lifecycle-transition detection, memory updates, relationship graph updates, and lifecycle-transition report generation.

/Grok/Gemini FIG. 9 is a user interface diagram illustrating a seamless transition from a social-feed interaction view to a guidance interaction view through a floating guidance invocation control.

FIG. 10 is a flow diagram illustrating deterministic axiom retrieval, constrained response compilation, and action-link generation in response to a lifecycle-specific query.

FIG. 11 is a system diagram illustrating a Family Legacy Vault and continuity-preservation store integrated with a lifecycle guidance platform.

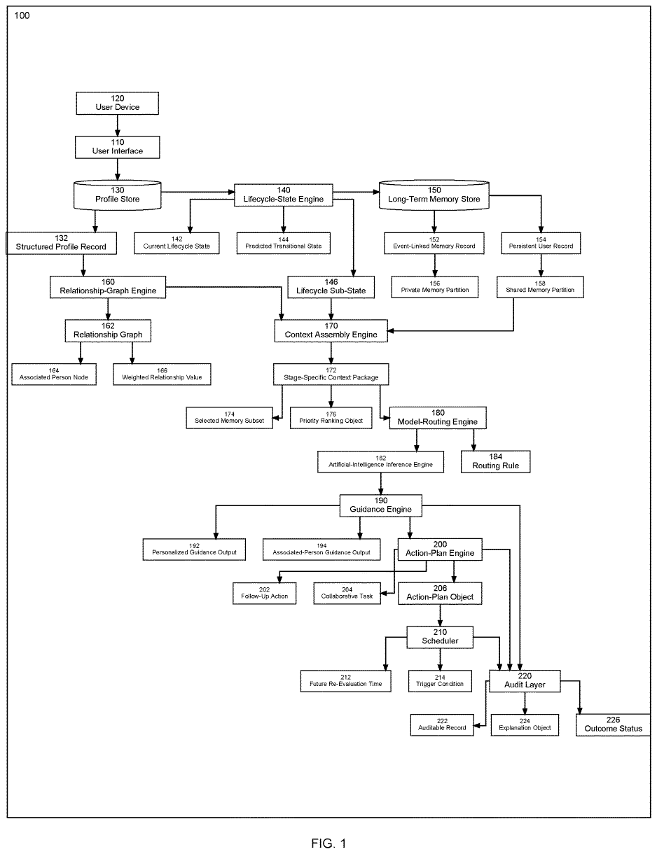

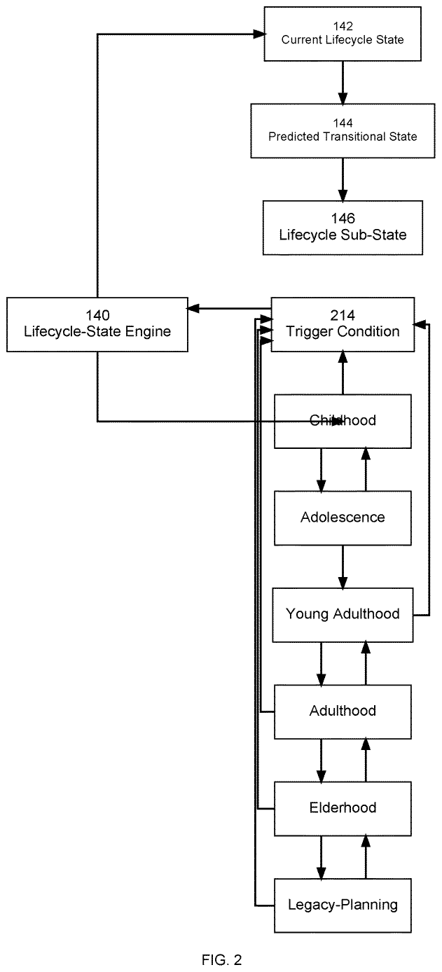

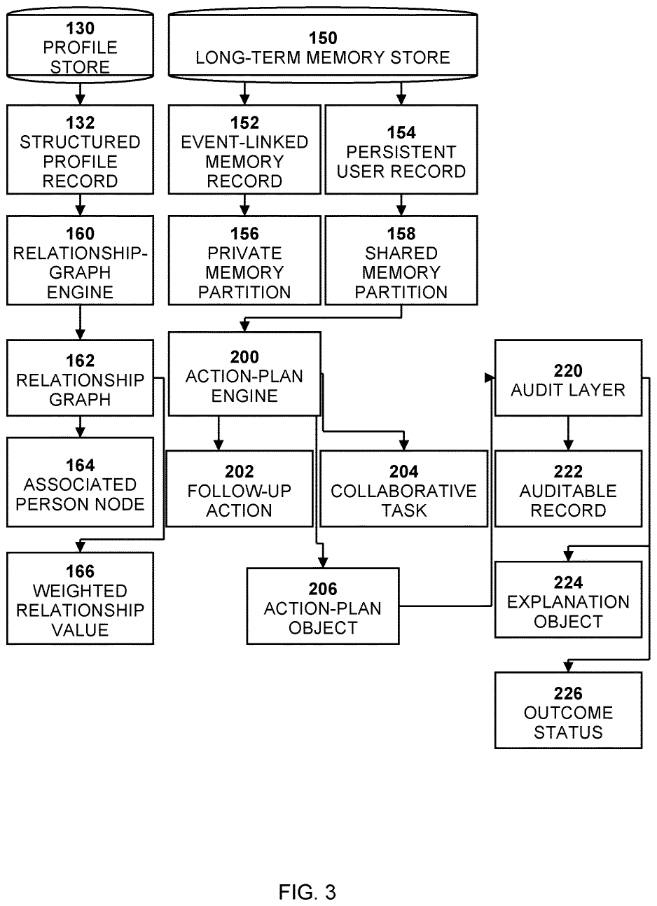

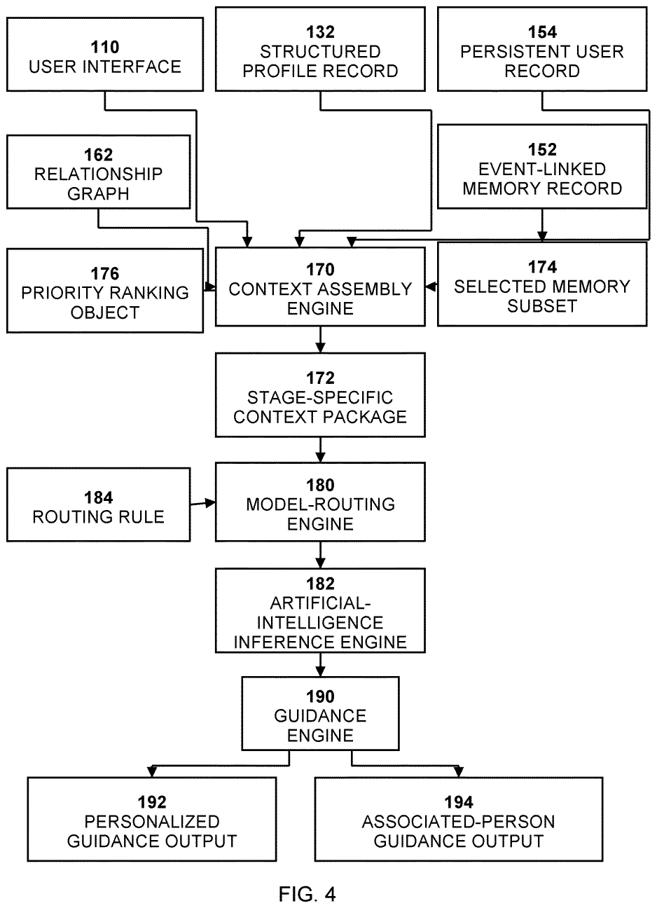

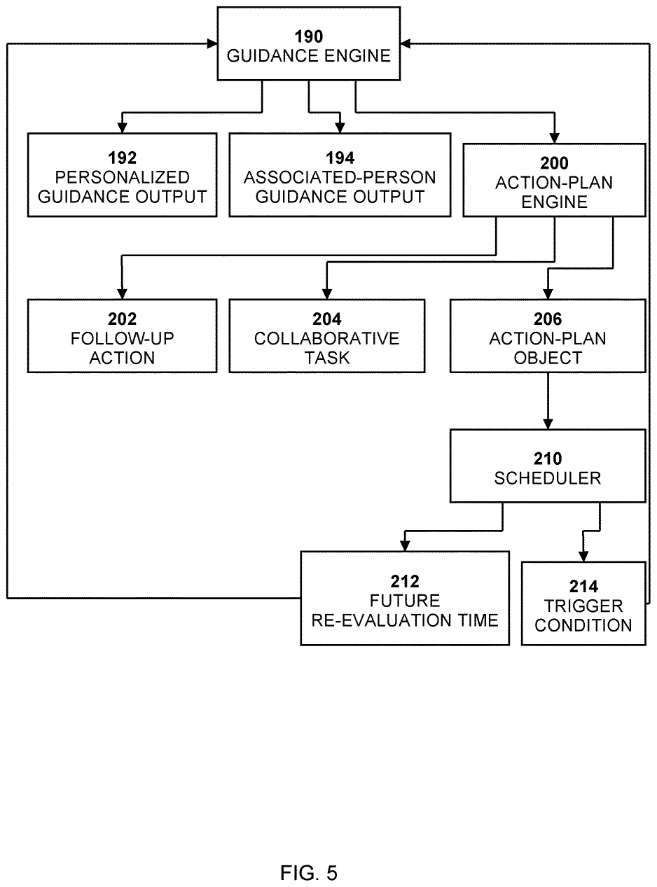

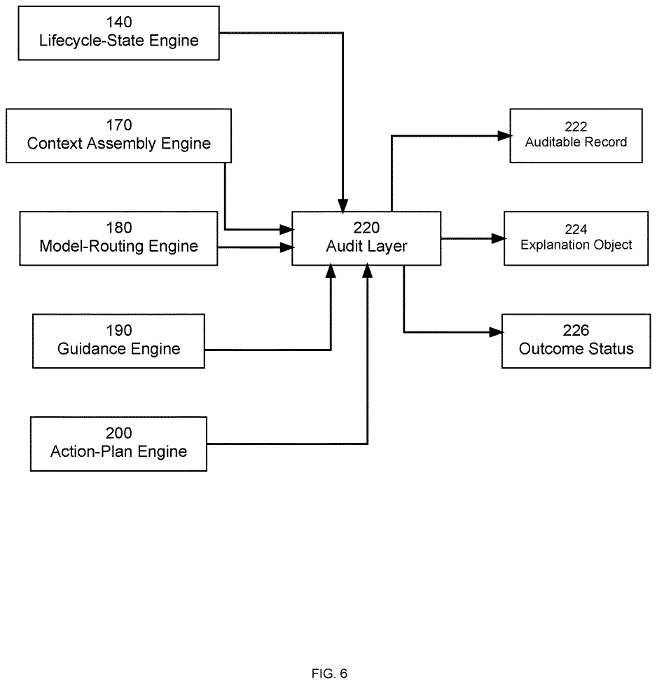

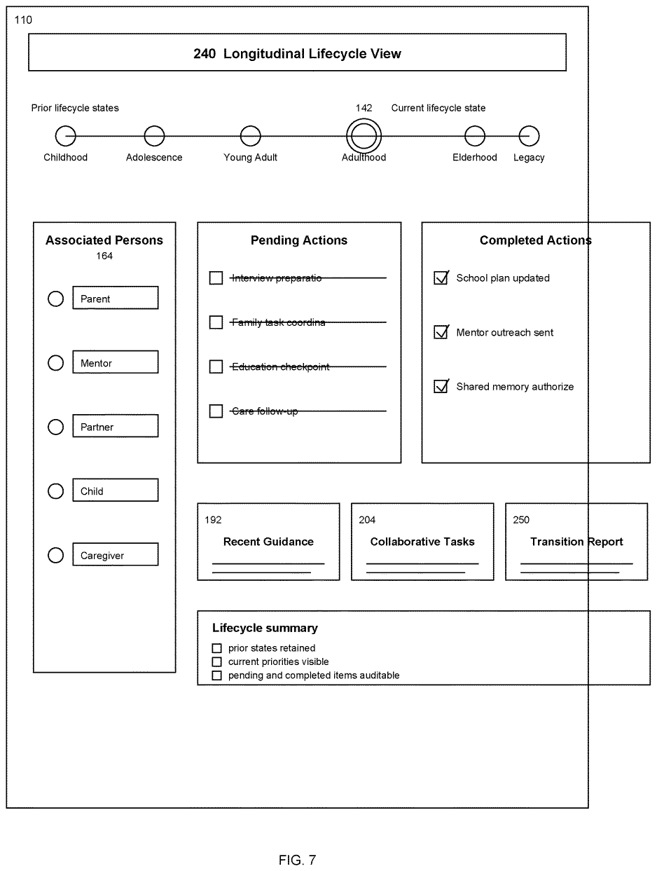

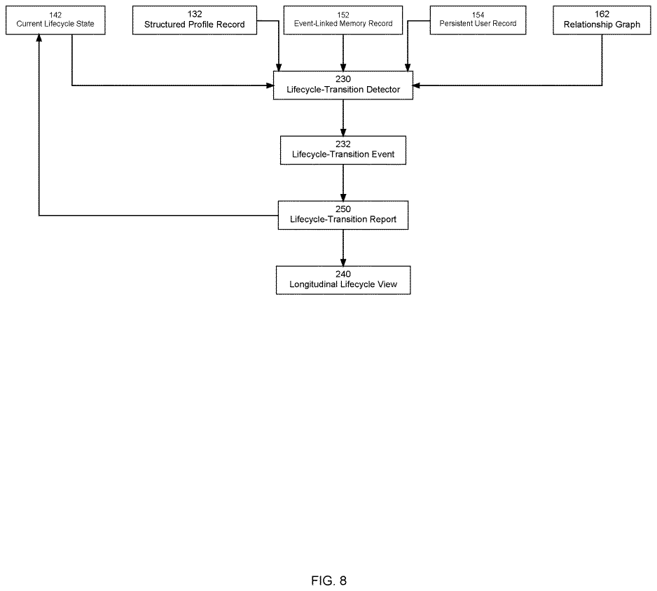

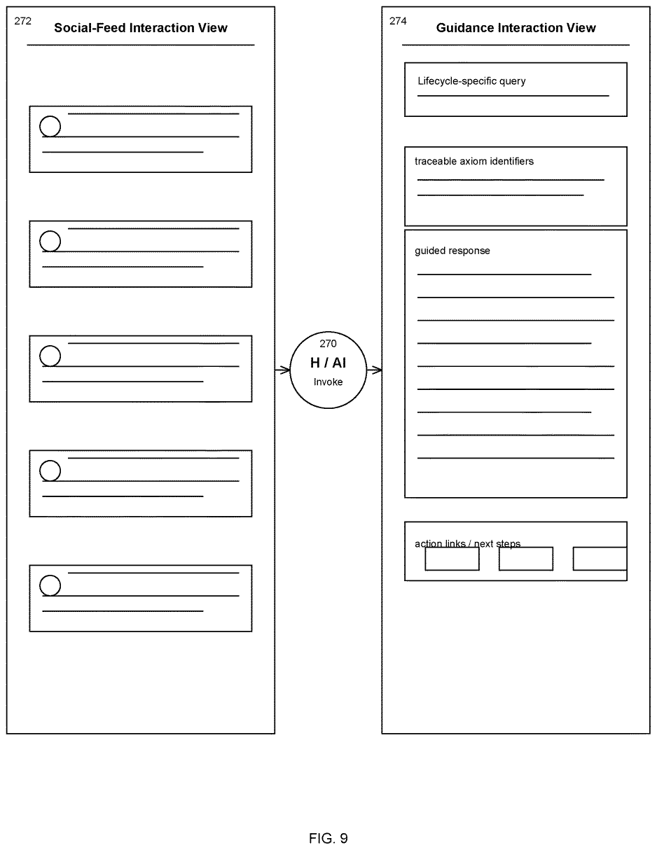

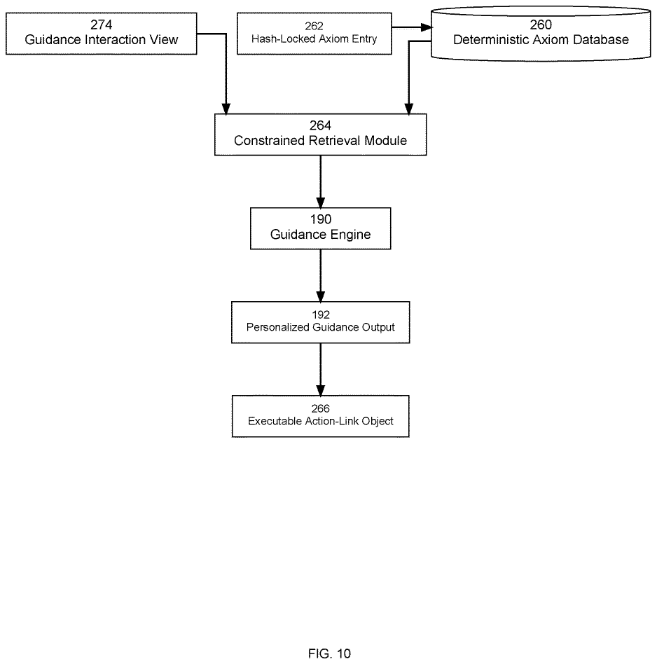

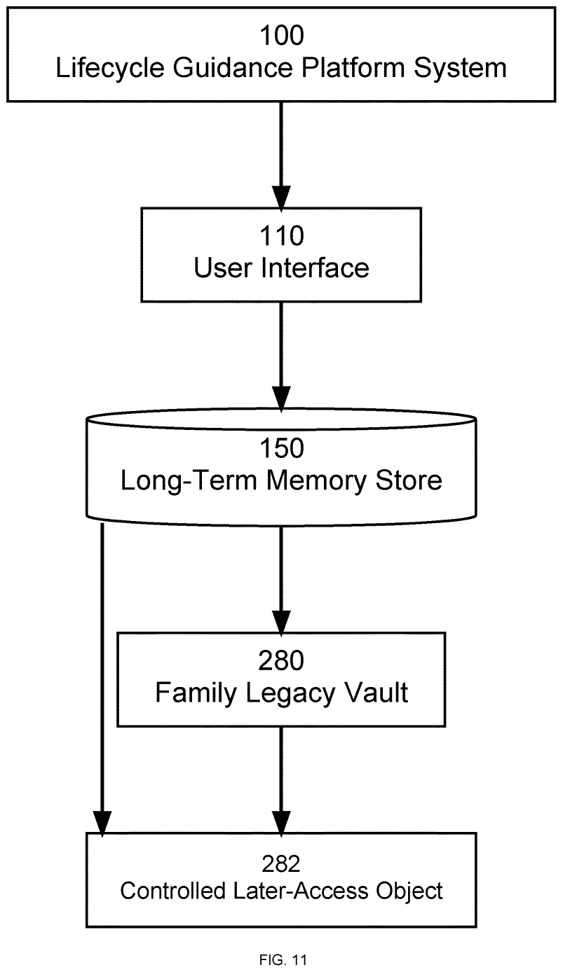

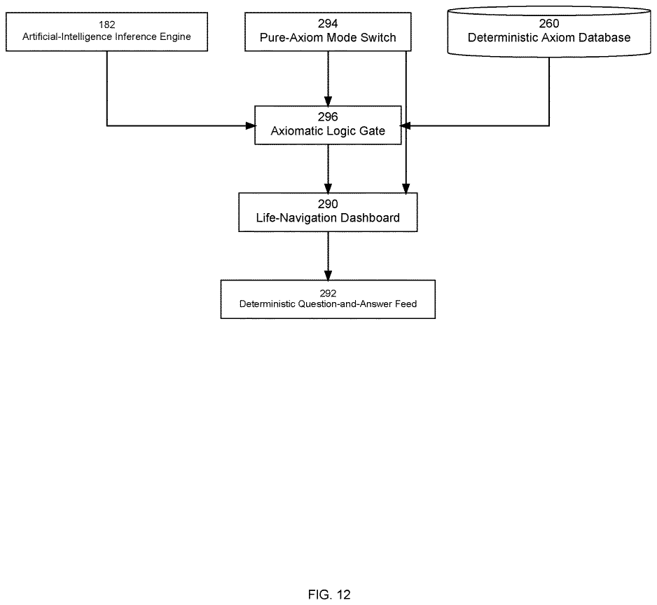

/Gemini FIG. 12 is a combined dashboard and fail-safe diagram illustrating a deterministic question-and-answer feed, a life-navigation dashboard, and a pure-axiom fail-safe switch.

### REFERENCE NUMERALS

100 lifecycle guidance platform system
110 user interface
120 user device
130 profile store
132 structured profile record
140 lifecycle-state engine
142 current lifecycle state
144 predicted transitional state
146 lifecycle sub-state
150 long-term memory store
152 event-linked memory record
154 persistent user record
156 private memory partition
158 shared memory partition
160 relationship-graph engine
162 relationship graph
164 associated person node
166 weighted relationship value
170 context assembly engine
172 stage-specific context package
174 selected memory subset
176 priority ranking object
180 model-routing engine
182 artificial-intelligence inference engine
184 routing rule
190 guidance engine
192 personalized guidance output
194 associated-person guidance output
200 action-plan engine
202 follow-up action
204 collaborative task
206 action-plan object
210 scheduler
212 future re-evaluation time
214 trigger condition
220 audit layer
222 auditable record
224 explanation object
226 outcome status
230 lifecycle-transition detector
232 lifecycle-transition event
240 longitudinal lifecycle view
250 lifecycle-transition report
260 deterministic axiom database
262 hash-locked axiom entry
264 constrained retrieval module
266 executable action-link object
270 floating guidance invocation control
272 social-feed interaction view
274 guidance interaction view
280 family legacy vault
282 controlled later-access object
290 life-navigation dashboard
292 deterministic question-and-answer feed
294 pure-axiom mode switch
296 axiomatic logic gate

### DETAILED DESCRIPTION OF THE INVENTION

### A. Technical Overview

The present disclosure relates to a full-lifecycle artificial-intelligence guidance platform system 100 configured to support users across multiple life stages using structured profile records 132, long-term memory records 152 and 154, relationship graph records 162, stage-specific context packages 172, personalized guidance outputs 192, associated-person guidance outputs 194, follow-up actions 202, collaborative tasks 204, scheduler operations 210, and auditable records 222.

Unlike session-limited chat systems, the disclosed platform is configured to preserve continuity over time. The platform can repeatedly receive user inputs, classify lifecycle stages, update memory and relationship structures, generate stage-aware outputs, and orchestrate future actions. The platform thereby transforms isolated interactions into structured, persistent, and auditable lifecycle guidance workflows.

In some embodiments, the platform further includes a deterministic axiom database 260 storing hash-locked axiom entries 262, and a constrained retrieval module 264 that retrieves authorized deterministic narrative templates without probabilistic modification.

In some embodiments, the user interface 110 further includes a floating guidance invocation control 270 enabling a user to transition seamlessly from a social-feed interaction view 272 to a guidance interaction view 274 within a unified interface session.

### B. User Interface and Input Collection

The user interface 110 may be implemented in a mobile application, web application, tablet application, desktop interface, smart speaker interface, wearable interface, in-vehicle interface, or hybrid interface. One or more user devices 120 may communicate with remote services over one or more networks.

The user interface 110 is configured to receive user-specific inputs including text, speech, checklists, schedules, mood indicators, profile updates, event entries, task completion signals, and responses to previous recommendations. Inputs may be manually entered, uploaded, inferred from prior interactions, or detected from application behavior or linked data sources.

In some embodiments, the user-specific inputs further comprise schooling inputs, identity-development inputs, relationship-formation inputs, job-planning inputs, parenting inputs, caregiving inputs, aging inputs, legacy-preservation inputs, AGI-era anxiety inputs, survival-assurance inputs, and intergenerational concern inputs.

### C. Profile Store and Structured Profile Records

The profile store 130 stores structured profile records 132. Each structured profile record 132 may include age-related data, role-related data, educational status, family role data, work role data, caregiving responsibilities, language preferences, communication preferences, learning preferences, trust settings, long-term goals, and prior interaction history.

The structured profile record 132 may include fixed fields and extensible fields. Fixed fields may include identity class, age group, current lifecycle state, and authorized associated-person categories. Extensible fields may include family structure descriptors, mentorship preferences, health-related self-descriptions, or legacy-transmission preferences.

### D. Lifecycle-state Engine

The lifecycle-state engine 140 is configured to assign a current lifecycle state 142 to the user. Example lifecycle states include childhood, adolescence, young adulthood, adulthood, elderhood, and legacy-planning. In some embodiments, the lifecycle-state engine 140 also assigns a predicted transitional state 144 and one or more lifecycle sub-states 146.

A lifecycle sub-state may represent finer distinctions such as early-learning childhood, transition-to-school, peer-development adolescence, college preparation, career-entry young adulthood, parenting adulthood, caregiving adulthood, elder support stage, or active legacy preparation.

Lifecycle-state assignment may be based on profile data, event data, age thresholds, role changes, repeated topic detection, task patterns, and relationship graph changes.

### E. Long-Term Memory Store

The long-term memory store 150 stores event-linked memory records 152 and persistent user records 154. Event-linked memory records 152 may include dated records associated with significant occurrences, such as schooling events, relationship events, parenting events, job transitions, caregiving obligations, retirement events, or legacy-related requests.

Persistent user records 154 may include stable preferences, long-term goals, value statements, recurring concerns, recurring strengths, learning preferences, communication preferences, and user-authorized guidance preferences.

In some embodiments, the long-term memory store 150 includes a private memory partition 156 and a shared memory partition 158. The private memory partition 156 stores user-restricted records, while the shared memory partition 158 stores records authorized for access by multiple users, such as family members, caregivers, mentors, or partners.

In some embodiments, the long-term memory store 150 further includes or is associated with a family legacy vault 280 configured to store selected user outputs, values, messages, or life-guidance artifacts as controlled later-access objects 282 for preservation and future retrieval.

In some embodiments, the long-term memory store 150 and associated permission controls maintain layered-permission management between a safety-kernel record subset and a prosperity-engine record subset, thereby allowing more restrictive governance, access control, or verification requirements for safety-critical records while permitting authorized broader use of non-safety planning, flourishing, or prosperity-oriented records.

### F. Relationship-Graph Engine

The relationship-graph engine 160 maintains a machine-readable relationship graph 162. The relationship graph 162 includes nodes 164 representing the user and associated persons. Associated persons may include parents, children, partners, teachers, mentors, peers, caregivers, relatives, or other authorized entities.

Edges between nodes may include weighted relationship values 166 representing affinity, dependency, caregiving relevance, educational relevance, emotional reliance, trust, communication intensity, or collaboration relevance.

The relationship graph 162 may be updated when new interactions occur, when roles change, when new persons are added, or when task outcomes indicate changing relevance of a relationship.

In some embodiments, the relationship-graph engine 160 uses at least some weighted relationship values for deterministic compatibility evaluation in mentoring, caregiving, educational, or partner-matching workflows.

### G. Context Assembly Engine

The context assembly engine 170 generates a stage-specific context package 172. The stage-specific context package may include selected profile data, selected memory records, selected relationship graph segments, active goals, unresolved tasks, pending actions, and one or more priority ranking objects 176.

The context assembly engine 170 may generate a selected memory subset 174 using recency filters, similarity scoring, lifecycle-state relevance, relationship relevance, urgency scoring, unresolved-task relevance, or user-configured preferences.

In some embodiments, the priority ranking object 176 applies an ethical weighting or weak-group prioritization rule when ranking a plurality of possible actions, resources, or guidance paths before generation of the personalized guidance output 192, such that a deterministically identified high-impact path for a vulnerable, under-supported, caregiving-dependent, or intergenerationally affected user is favored.

For example, if a teenager raises a schooling concern, the selected memory subset may include prior academic events, past study-plan outcomes, parent-teacher interactions, and mentor-linked records. If an elder user raises a caregiving concern, the selected memory subset may include caregiver schedules, medication reminders, family relationship weights, and unresolved care tasks. If a legacy-stage user raises preservation concerns, the selected memory subset may include value statements, designated recipients, major life events, and legacy-transfer tasks.

In some embodiments, the context assembly engine 170 or a related retrieval module queries a hash-verified axiom vector store to retrieve deterministic narrative templates, execution-linked templates, or resource-linked templates without permitting uncontrolled probabilistic alteration of protected guidance content.

In some embodiments, the context assembly engine 170 includes, for at least some queries, one or more hash-verified axiom records corresponding to a detected life-stage dimension or life-dimension tag.

### H. Model-Routing Engine

The model-routing engine 180 routes the stage-specific context package 172 to one or more artificial-intelligence inference engines 182 according to one or more routing rules 184. Routing may depend on lifecycle state, topic type, latency tolerance, cost threshold, confidence threshold, language, output type, or safety configuration.

In some embodiments, different models or subsystems are selected for explanation generation, planning generation, summarization, emotional support, or multi-party coordination.

In some embodiments, the model-routing engine 180 operates in conjunction with an axiomatic logic gate 296 that evaluates external model outputs against authorized axiomatic constraints and selectively triggers a pure-axiom mode switch 294 to disconnect or restrict one or more external model pathways when a conflict is detected.

### I. Guidance Engine

The guidance engine 190 generates a personalized guidance output 192 responsive to the user-specific input and the stage-specific context package 172. The guidance output may include explanatory text, encouragement, structured plans, decision alternatives, reminders, milestone suggestions, or other stage-appropriate content.

The guidance engine 190 may also generate an associated-person guidance output 194. For example, a user-specific concern may result in one output tailored for a child and another output tailored for a parent or guardian. The child-facing output may emphasize clarity and encouragement, while the parent-facing output may emphasize support actions, oversight, and timing.

In some embodiments, the personalized guidance output 192 includes or is associated with an executable action-link object 266 configured to trigger registration, scheduling, financing-interface access, educational-path activation, health-plan enrollment, or other machine-enabled follow-up operations.

In some embodiments, the personalized guidance output 192 is traceable to one or more authorized axiom identifiers, and may be presented within a guidance interaction view 274 invoked through the floating guidance invocation control 270.

### J. Action-Plan Engine

The action-plan engine 200 generates one or more follow-up actions 202 and one or more collaborative tasks 204. A follow-up action may include a same-day task, deferred task, checkpoint, reminder, reflection step, or scheduled review step. A collaborative task may include an action assigned to a parent, partner, mentor, or caregiver.

The action-plan engine 200 may generate an action-plan object 206 that stores dependencies, deadlines, assignees, escalation criteria, completion status, and re-evaluation conditions.

In some embodiments, the action-plan engine 200 generates at least one executable action-link object 266 configured to invoke a learning-path registration flow, a health-management plan, a financing-interface access flow, or a digital-resource access flow.

### K. Scheduler and Re-Evaluation

The scheduler 210 assigns a future re-evaluation time 212 or one or more trigger conditions 214 associated with a given action-plan object 206.

Example trigger conditions 214 include expiration of a time interval, completion of a task, non-completion of a task, receipt of a new input, a detected event, or a lifecycle transition.

Upon occurrence of a trigger, the system may retrieve updated profile data, updated memory records, updated relationship graph data, and updated outcomes, and may generate revised guidance and revised action plans.

### L. Audit Layer

The audit layer 220 stores an auditable record 222 associated with lifecycle guidance operations. The auditable record may include input snapshots, lifecycle-state determinations, selected memory references, relationship graph references, routing decisions, generated outputs, action plans, explanation objects, and outcomes.

An explanation object 224 may identify which data elements or categories of data contributed to a given output. Outcome status 226 may reflect completed, partially completed, overdue, unresolved, escalated, improved, or deferred states.

In some embodiments, the audit layer 220 performs a data-integrity check for at least some retrieved axiom records.

some embodiments, the audit layer 220 includes cryptographic provenance verification for at least some guidance outputs.

### M. Longitudinal Lifecycle View and Reporting

The user interface 110 may provide a longitudinal lifecycle view 240 showing prior lifecycle states, the current lifecycle state 142, the predicted transitional state 144, pending actions, completed actions, and associated persons.

The lifecycle-transition detector 230 may detect lifecycle-transition events 232 based on age thresholds, role changes, schooling transitions, job transitions, caregiving changes, retirement, or legacy-planning initiation.

In response, the system may generate a lifecycle-transition report 250 comparing prior and current lifecycle states, key memory summaries, pending tasks, completed actions, and changing relationship relevance.

In some embodiments, the user interface 110 further presents a deterministic question-and-answer feed 292 and a life-navigation dashboard 290 showing civilization-flourishing or lifecycle-progress indicators based at least in part on the lifecycle-transition report 250.

### N. Example Embodiments

In one embodiment, a child user asks for help with school performance. The system classifies the user into a childhood state, retrieves school-related memory records, retrieves parent-linked relationship records, generates a child-facing study output, generates a parent-facing support output, creates a study task, and schedules re-evaluation after an examination date.

In another embodiment, a teenager raises questions relating to social conflict and future identity. The system retrieves prior emotional and educational records, updates mentor-linked graph edges, generates a personalized reflective guidance output, and assigns one or more collaborative support tasks.

In another embodiment, an adult user raises a job-transition concern while also having parenting responsibilities. The system ranks occupational and family priorities, generates a staged action plan, assigns collaborative tasks to family members, and schedules a follow-up tied to interview and task-completion status.

In another embodiment, an elder or legacy-stage user raises concerns about preserving personal knowledge, values, or care for descendants. The system retrieves family records, designated recipient records, prior values, and legacy preferences, and generates structured preservation outputs and legacy-action tasks.

In one embodiment, a user invokes a deterministic query regarding educational or vocational anxiety. The constrained retrieval module 264 retrieves one or more hash-locked axiom entries 262 from the deterministic axiom database 260 without probabilistic modification, and the guidance engine 190 generates a composite interface element containing both a textual guidance component and an executable action-link object 266.

In one embodiment, a user viewing a social-feed interaction 272 activates the floating guidance invocation control 270 to transition seamlessly to a guidance interaction view 274, where a lifecycle-specific query is processed with cryptographic provenance and traceable axiom identifiers.

In one embodiment, an axiomatic logic gate 296 detects a conflict between an external model output and an authorized axiomatic constraint, causing the pure-axiom mode switch 294 to disconnect one or more external model pathways and revert the system to a restricted deterministic guidance mode.

### O. Implementation Variations

The described engines may be implemented in software, hardware, firmware, or combinations thereof, and may run locally, remotely, or in distributed cloud infrastructure.

Artificial-intelligence inference engines 182 may include language models, reasoning engines, planners, classifiers, summarizers, or hybrid model systems.

The disclosed embodiments are not limited to the specific lifecycle states, sub-state labels, or relationship-weighting schemes described herein.

It will be understood by persons of ordinary skill in the art that the particular modules, boundaries, data structures, storage partitions, interaction modes, and guidance rules described above are illustrative rather than limiting. The disclosed subject matter may be implemented using cloud-based, on-device, distributed, hybrid, or other computational architectures without departing from the scope of the invention.

The foregoing description is intended to illustrate, and not to limit, the disclosed embodiments. Variations, substitutions, combinations, and modifications may be made without departing from the scope of the appended claims.

1. A computer-implemented lifecycle guidance platform system, comprising: one or more processors; a user interface configured to receive, from one or more user devices, user-specific inputs comprising textual inputs, voice inputs, profile inputs, event inputs, or task-status inputs; a profile store configured to store structured profile records associated with a user, the structured profile records including at least age-related data, role-related data, preference data, and historical interaction data; a lifecycle-state engine executed by the one or more processors and configured to classify the user into a current lifecycle state selected from a plurality of lifecycle states comprising at least a childhood state, an adolescent state, a young-adult state, an adult state, an elder state, and a legacy-planning state; a long-term memory store configured to store event-linked memory records and persistent user records associated with the user; a relationship-graph engine configured to maintain a machine-readable relationship graph representing relationships between the user and one or more associated persons; a context assembly engine configured to generate, based on the current lifecycle state, the structured profile records, the long-term memory store, and the relationship graph, a stage-specific context package for inference; a model-routing engine configured to route the stage-specific context package to at least one artificial-intelligence inference engine; a guidance engine configured to generate a personalized guidance output responsive to the user-specific inputs and the stage-specific context package; an action-plan engine configured to generate one or more machine-generated follow-up actions, reminders, checkpoints, or collaborative tasks associated with the personalized guidance output; a scheduler configured to assign a future re-evaluation time or trigger condition associated with the one or more follow-up actions; and an audit layer configured to store an auditable record of at least the user-specific inputs, the current lifecycle state, the stage-specific context package, the personalized guidance output, and the one or more follow-up actions, wherein the system further comprises a cryptographically protected axiom vector database storing hash-locked axiom entries and a retrieval-constrained response module configured, for at least some lifecycle-guidance operations, to retrieve authorized deterministic narrative templates without probabilistic modification, and wherein at least some generated outputs are associated with provenance verification and one or more authorized axiom identifiers, wherein the lifecycle guidance platform system continuously updates guidance for the user across multiple lifecycle states using the long-term memory store and the relationship graph.

2. The system of claim 1, wherein the lifecycle-state engine is further configured to assign the user to a sub-state within the current lifecycle state based on at least one of educational status, family status, occupational status, caregiving status, health status, or legacy-planning status, and wherein the sub-state may further reflect a civilization-flourishing or life-navigation status derived from one or more deterministic guidance dimensions.

3. The system of claim 1, wherein the long-term memory store comprises a private memory partition associated only with the user and a shared memory partition associated with two or more users linked in the relationship graph, and optionally a legacy-preservation partition or family legacy vault partition for controlled future access.

4. The system of claim 1, wherein the relationship-graph engine is configured to assign at least one weighted relationship value representing affinity, dependency, caregiving relevance, educational relevance, or collaboration relevance between the user and the one or more associated persons, and to use at least some weighted relationship values for deterministic compatibility evaluation in mentoring, caregiving, educational, or partner-matching workflows.

5. The system of claim 1, wherein the context assembly engine is configured to select, for inclusion in the stage-specific context package, a subset of stored memory records according to recency, relevance score, lifecycle-state relevance, or relationship-graph relevance, and, for at least some queries, to include one or more hash-verified axiom records corresponding to a detected life-stage dimension.

6. The system of claim 1, wherein the guidance engine is configured to generate a first personalized guidance output for the user and a second personalized guidance output for a parent, guardian, partner, caregiver, mentor, or associated person linked to the user in the relationship graph, the personalized guidance output being optionally traceable to one or more authorized axiom identifiers.

7. The system of claim 1, wherein the action-plan engine is configured to generate a multi-step action plan comprising at least an immediate action, a deferred action, and a future check-in action, and to generate at least one executable action-link object configured to invoke a learning-path registration flow, a health-management plan, a financing-interface access flow, or a digital-resource access flow.

8. The system of claim 1, wherein the scheduler is configured to trigger re-evaluation based on expiration of a time interval, receipt of a new user-specific input, completion of a task, non-completion of a task, or detection of a change in the current lifecycle state.

9. The system of claim 1, wherein the audit layer is configured to store, in association with the auditable record, an explanation object identifying data elements that contributed to generation of the personalized guidance output, and to perform a data-integrity check for at least some retrieved axiom records, including cryptographic provenance verification for at least some guidance outputs.

10. The system of claim 1, wherein the user interface is further configured to present a longitudinal lifecycle view showing prior lifecycle states, current lifecycle state, pending follow-up actions, and completed actions for the user, and to provide a seamless transition from social-feed interaction to guidance invocation through a persistent or floating interface control, and optionally to present a deterministic question-and-answer feed or a civilization-flourishing dashboard.

11. A computer-implemented method for lifecycle-specific guidance generation, comprising: receiving, by one or more processors from one or more user devices, user-specific inputs associated with a user; retrieving, from a profile store, structured profile records associated with the user; classifying, by a lifecycle-state engine, the user into a current lifecycle state selected from a plurality of lifecycle states; retrieving, from a long-term memory store, memory records associated with the user; retrieving or updating, by a relationship-graph engine, a relationship graph associated with the user; assembling, by a context assembly engine, a stage-specific context package based on the current lifecycle state, the structured profile records, the memory records, and the relationship graph; routing, by a model-routing engine, the stage-specific context package to at least one artificial-intelligence inference engine; retrieving, from a cryptographically protected axiom vector database, one or more hash-verified axiom records associated with the current lifecycle state or a detected life-dimension tag; generating, by a guidance engine, a personalized guidance output for the user; generating one or more follow-up actions associated with the personalized guidance output; scheduling a future re-evaluation time or trigger condition associated with the one or more follow-up actions; and storing an auditable record associated with the personalized guidance output and the one or more follow-up actions.

12. The method of claim 11, further comprising detecting a lifecycle-transition event and updating the current lifecycle state to a new lifecycle state in response to the lifecycle-transition event.

13. The method of claim 11, wherein the user-specific inputs comprise at least one input associated with schooling, identity development, relationship formation, job planning, parenting, caregiving, aging, or legacy preservation, including an AGI-era anxiety input, a survival-assurance input, or an intergenerational concern input.

14. The method of claim 11, further comprising generating a first output view for the user and a second output view for an associated person linked in the relationship graph.

15. The method of claim 11, further comprising storing, in the long-term memory store, a summary record representing at least a portion of the personalized guidance output and an outcome status associated with the one or more follow-up actions, the summary record being optionally preserved in a family legacy vault or continuity-preservation record.

16. The method of claim 11, wherein generating the one or more follow-up actions comprises generating at least one task assigned to the user and at least one collaborative task assigned to an associated person linked in the relationship graph, and optionally generating at least one machine-enabled deep link or resource-trigger interface associated with the task.

17. The method of claim 11, further comprising ranking a plurality of user priorities based on lifecycle-state relevance, memory relevance, urgency, relationship relevance, or pending-task relevance before generating the personalized guidance output, and, for at least some query categories, applying an ethical weighting or weak-group prioritization rule to favor a deterministically identified high-impact path.

18. A non-transitory computer-readable medium storing instructions that, when executed by one or more processors, cause the one or more processors to: receive user-specific inputs associated with a user; retrieve structured profile records associated with the user; determine a current lifecycle state for the user; retrieve memory records associated with the user from a long-term memory store; retrieve or update a relationship graph associated with the user; generate a stage-specific context package based on the current lifecycle state, the structured profile records, the memory records, and the relationship graph; route the stage-specific context package to at least one artificial-intelligence inference engine; generate a personalized guidance output and one or more follow-up actions for the user; schedule a future re-evaluation time or trigger condition; and store an auditable record associated with the personalized guidance output and the one or more follow-up actions, wherein the instructions further cause the one or more processors, for at least some outputs, to retrieve one or more non-probabilistic response templates from a protected deterministic knowledge structure and output a composite interface element containing both a textual guidance component and an actionable trigger component.

19. The non-transitory computer-readable medium of claim 18, wherein the instructions further cause the one or more processors to maintain separate memory records for private user interactions and shared family or group interactions, and optionally to apply layered-permission management between a safety-kernel record subset and a prosperity-engine record subset.

20. The non-transitory computer-readable medium of claim 18, wherein the instructions further cause the one or more processors to generate a lifecycle-transition report comparing a prior lifecycle state, the current lifecycle state, pending actions, and completed actions for the user, and optionally to generate a civilization-flourishing or life-navigation dashboard based at least in part on the lifecycle-transition report.
